(19) United States
(12) Patent Application Publication
(10) Pub. No.: US 2011/0089659 A1
(43) Pub. Date: Apr. 21, 2011

(54) Weight Displacement Steering Mechanism

(75) Inventor: Justin P. Hunt, Logan, UT (US)

(73) Assignee: Utah State University, North Logan, UT (US)

(21) Appl. No.: 12/904,693

(22) Filed: Oct. 14, 2010

Related U.S. Application Data
(60) Provisional application No. 61/251,780, filed on Oct. 15, 2009.

(51) Int. Cl. B60G 5/03; B62D 3/02

(52) U.S. Cl. 280/124.121; 280/93.513

(57) ABSTRACT

A steering mechanism that operates by shifting weight in the desired direction. One embodiment includes an arm perpendicularly hinged to the underside of a platform. Connected to the bottom of the arm is a pivoting axle, which is in turn linked to a series of gears that lead back to the platform to form concurrent motion between the platform and axle. Supporting the platform in place is a pair of springs fastened to the arm on hinged mounts secured in place by a pair of stationary mounts fixed to the platform.

### RELATED APPLICATIONS

This application claims the benefit under 35 U.S.C. §119(e) of U.S. Provisional Patent Application No. 61/251,780, filed Oct. 15, 2009, and titled “Weight Displacement Steering Mechanism”, which is incorporated herein in its entirety by reference.

### FIELD OF THE INVENTION

This application relates to platform steering systems, and more specifically to a system with a pair of bevel gears that connect and form concurrent motion between the platform and the axle for use on systems such as, but not limited to, skateboards, sleds, and other stand-on/ride-on platform apparatuses.

### BACKGROUND OF THE INVENTION

Skateboarding and sledding are both popular sports—especially among a younger crowd. Unfortunately, both share in a general deficiency of control. Every year thousands of people are injured in skateboarding and sledding accidents, and many of these accidents are caused by a vehicles' inability to perform turns sharp enough to avoid obstacles. For some unclear reason the issue of turning for skateboards and sleds has been chosen to be addressed separately by most inventors.

Several designs for turning mechanisms have been proposed over the years. U.S. Pat. No. 4,054,297 to Solimine (1977) suggests a system of pivotal arms and rockers which allows for more maneuverability than present models. The design, however, is only meant for skateboards and does not allow for a singular wheel, ski, or skate to be implemented. Nor does it suggest utilization for a pair of skis or a pair of skates. Furthermore, Solimine's patent appears to over complicate the issue; its numerous moving and rotating parts would likely deter a manufacturer who is seeking a more economic and simplistic approach to a simple problem. In addition, the patent requires a slightly different design for the front and back units, enough so that it would burden the manufacturer with the unwanted cost of producing two different mechanisms. Finally, Solimine's steering mechanism stands higher than a traditional skateboard truck, meaning the cumbersome appearance will deter skateboarders who are use to the low slung look and feel of present skateboard designs.

U.S. Pat. No. 5,169,166 to Brooks (1992) demonstrates a design that has the wheels and platform tilt from side to side in concurrent motion. Although economical from a manufacturing standpoint, Brooks' design does not address a skateboarder's need for the ability to perform sharp hairpin turns to avoid obstacles in congested urban area. Furthermore, the design requires the rider to tilt the skateboard platform excessively to perform turns, which can cause more skateboarders to lose their balance during maneuvers. Brooks' later patented two revised versions of this design. U.S. Pat. No. 5,232,235 to Brooks (1992) and U.S. Pat. No. 5,330,214 to Brooks (1994) are both very similar to the first design in nature, but neither of these patents address the issue of maneuverability or structure to an adequate extent.

Several designs have also been proposed to solve the same issue for sleds. U.S. Pat. No. 4,036,506 to Scheib (1977) suggests a steering wheel connected to a series of runners that tilt from side-to-side. Although this system works, the steering, wheel system can be more dangerous if a crash does occur because its small surface area concentrates the impact pressure and can cause chest and neck injuries upon collision. U.S. Pat. No. 4,101,142 to Turner (1978), U.S. Pat. No. 6,575,479 to Combs (2003), U.S. Pat. No. 4,796,902 to Capra (1989) and many others employ a similar steering mechanism to Scheib, in that a protruding steering wheel or handle bars are required to operate the system.

Thus, prior art in the field of steering mechanisms for skateboards, sleds, and similar vehicles, is known to suffer from one or more of the follow disadvantages:

(a) The mechanism is incapable of incorporating a single wheel, ski, or skate instead of a pair.
(b) The mechanism is excessively complicated, limiting the practicality of production.
(c) The mechanism has a different design for the front and back steering units, resulting in an additional cost to manufacture.
(d) The mechanism is cumbersome and therefore unappealing to the consumer.
(e) The mechanism is only capable of performing shallow turns.
(f) The mechanism requires excessive tilting of the stand-on/ride-on platform to perform a sharp turn, which can cause the rider to lose balance.
(g) The mechanism requires the use of a protruding steering wheel or handlebars, which can be unsafe at high speeds.

Therefore, there exists a need for a weight displacement steering mechanism that can address these deficiencies.

### SUMMARY OF THE INVENTION

The present disclosure describes a steering system comprising a platform, a swing arm perpendicularly attached to the platform, a spring system attached to the swing arm supporting the platform, a rotating wheeled axle mounted to the bottom of the swing arm and a pair of bevel gears that connect and form concurrent motion between the, platform and the axle. Steering is activated by weight displacement or weight, transfer causing the platform to tilt toward the desired steering direction.

### BRIEF DESCRIPTION OF THE DRAWINGS

Understanding that drawings depict only certain preferred embodiments of the invention and are therefore not to be considered limiting of its scope, the preferred embodiments are described and explained with additional specificity and detail through the use of the accompanying drawings in which:

FIG. 1A shows an isometric view of the steering mechanism.

FIG. 1B shows a front view of the steering mechanism.

FIG. 1C shows a side view of the steering mechanism.

FIG. 1D shows an isometric view of the steering mechanism with the axle removed for clarity.

FIG. 2 illustrates the steering mechanism with an alternative system for restoring the base platform to a level position.

FIG. 3 illustrates the steering mechanism with only one wheel in accordance with one embodiment.

FIG. 4 illustrates the steering mechanism with runners or skates instead of wheels in accordance with one embodiment.

FIG. 5 illustrates the steering mechanism with only one runner or skate in accordance with one embodiment.

FIG. 6 illustrates the steering mechanism with skis instead of wheels in accordance with one embodiment.

FIG. 7 illustrates the steering mechanism with only one ski in accordance with one embodiment.

### DETAILED DESCRIPTION OF SELECTED EMBODIMENTS

In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as represented in the drawings, is not intended to limit the scope of the invention, but is merely representative of the various embodiments of the invention.

The present disclosure describes a weight displacement steering mechanism for controlling the direction of motion of a vehicle on wheels, skates, runners or the like. The shifting or repositioning of weight on the system, also referred to as weight transfer or weight displacement, initiates and controls the steering mechanism and provides a number of advantages including the following.

(a) The use of this steering mechanism allows users far more control over their skateboard, or other transportation device, permitting even beginners to travel congested areas that would normally be too difficult to navigate through using present skateboard models.
(b) The steering mechanism has the advantage of a greater turn-to-tilt ratio due to the sizing of the bevel gears. This will allow riders the ability to maintain their balance even when performing a sharp turn.
(c) The use of springs as a means of retention will allow manufactures to offer springs of various strengths to better suit the weight and height of the customer in order to maximize the product's efficiency.
(d) The steering mechanism allows for a singular or multiple wheel design. The use of the steering mechanism equipped with a singular wheel would likely prove to be useful for a bi or tri wheeled vehicle.
(e) The steering mechanism also allows for a singular or multiple ski/skate design. Similarly, the use of a single ski/skate design would be effective for a bi or tri ski/skate vehicle.
(f) The steering mechanism design is far more compact and low slung than present patents with the same intention.
(g) The front and back steering mechanism is of the same design, which will result in easy unit manufacturing.

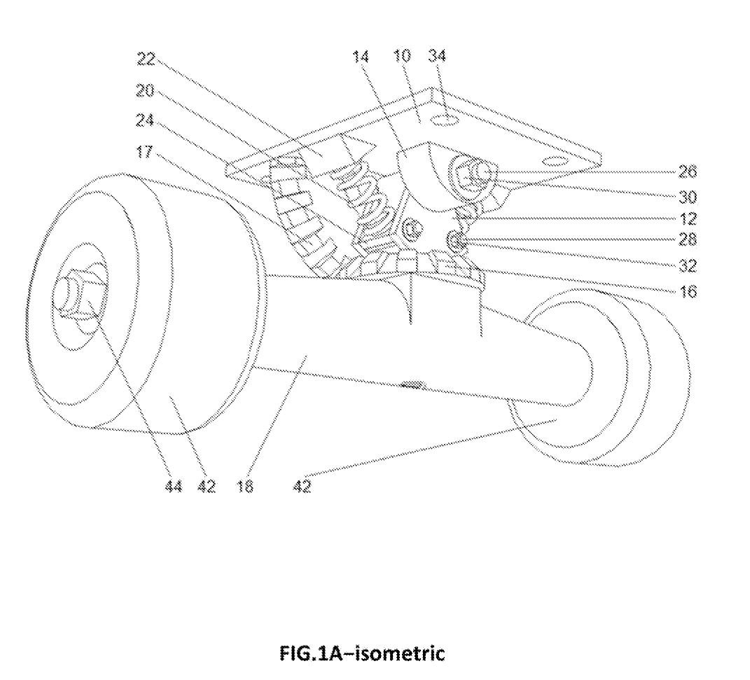

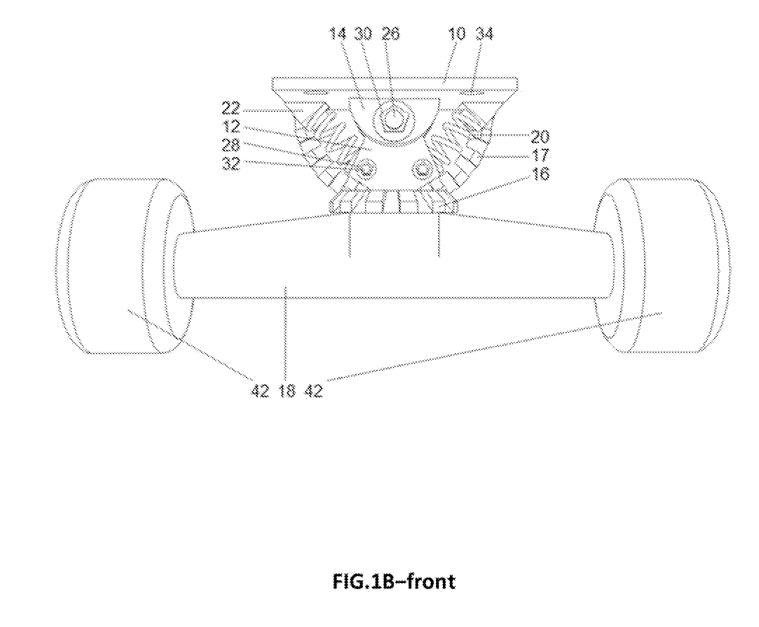

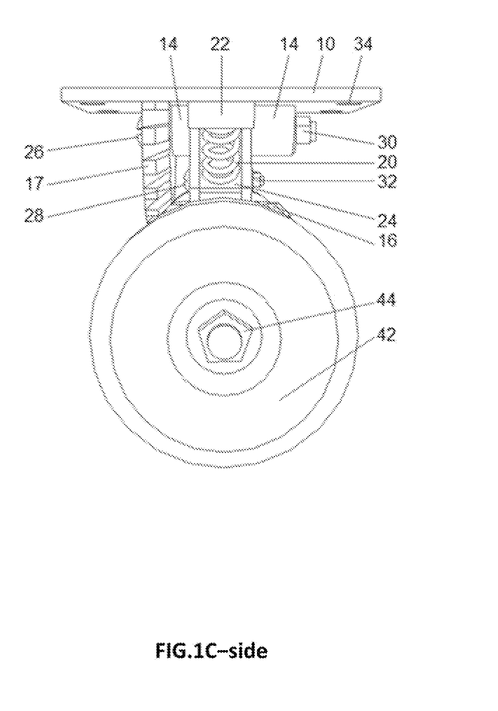

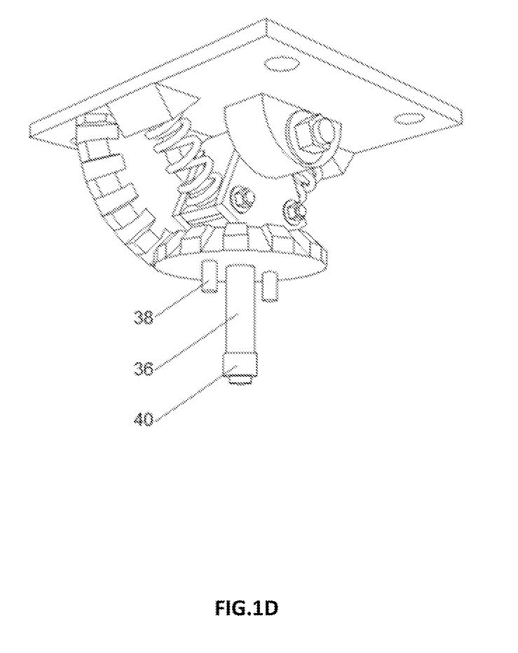

These advantages will become apparent in the following detailed description of the weight displacement steering mechanism. One embodiment of the steering mechanism is illustrated in FIG. 1A (isometric), FIG. 1B (front), FIG. 1C (side) and FIG. 1D (isometric with axle removed). The steering mechanism has a base platform 10 which has holes 34 for fastening to a larger stage. Joined to the underside of the base platform 10 is the swing arm mount 14 that is attached to the swing arm 12 by means of a bolt 26 and fastener 30. Bolt 26 is free to rotate within swing arm 12, thus effectively creating a hinge structure. A suspension or damping system utilizing springs is constructed to support the base platform 10 and assist in positioning it back to the neutral position after it has been tilted by a weight transfer. Pivoting spring mounts 24 are fixed to the bottom of the swing arm 12 by small bolts 28 and fasteners 32 and are used to pressure fit springs 20 between the pivoting spring mounts 24 and the non-pivoting spring mounts 22 . Attached to the bottom of the swing arm 12 by means of the arm bolt 36 and secured in place by the swing arm fastener 40 is a first bevel gear 16 which interlocks with the pivoting axle 18 by way of pins 38 as shown in FIG. 1D. The first bevel gear 16 is free to pivot around the arm bolt 36. The relationship between the first bevel gear 16 and the pivoting axle 18 is fixed, thus their angular degree of turning or pivoting during steering is the same. Perpendicularly interconnected and engaged to the first bevel gear is a second bevel gear 17 with an approximate half circle geometry. The straight edge of the second bevel gear 17 is fastened to the underside of the base platform and the same bolt 26 that passes through the swing arm 12 is fastened to the second bevel gear 17. Finally, for a skate board truck of similar functional type application, a pair of wheels 42 are fastened to the ends of the pivoting axle and secured in place by wheel fasteners 44.

When the weight displacement on the base platform 10 is equally distributed on each side, the base platform 10 is level and the pivoting axle 18 is perpendicular to bolt 26. When the weight on the base platform 10 is shifted to one side, the base platform 10 tilts to that side causing the second bevel gear 17 to rotate which causes the first bevel gear 16 to turn. The resultant action is the pivoting axle 18 pivots, thus steering the system. The springs 20 provide a restoring force to bring the base platform 10 to a level position and the pivoting axle 18 back to its original orientation.

In this preferred embodiment, the material used for the various components is aluminum, except for the wheels which are polyurethane. However; plastics, steel, or other materials could be used in place of aluminum, and any wheel made of plastic, rubber, metal, or other material is a compatible substitute for polyurethane. Paints and laminations could also be added for additional protection or simply to enhance the appeal. Composite materials may also be used for their desirable strength to weight properties.

The weight displacement steering system can be adjusted to create different steering characteristics. For example, the size ratio between the first bevel gear 16 and the second bevel gear 17 will affect the amount of steering for a given weight displacement or tilt to the base platform 10. A smaller ratio of the diameter of the first bevel gear 16 to the diameter of the second bevel gear 17 results in a more sensitive or responsive steering system, i.e. a smaller displacement or tilting of the base platform 10 is required to turn the pivoting axle 18.

Another component that can be adjusted to change the steering characteristics is the spring 20. A steering mechanism built with springs 20 having a greater spring constant will require a greater displacement for the same angle of steering that would be experienced by a system with a spring 20 having a lower spring constant. Simply stated, a stiffer spring will require a greater force to turn the weight displacement steering mechanism.

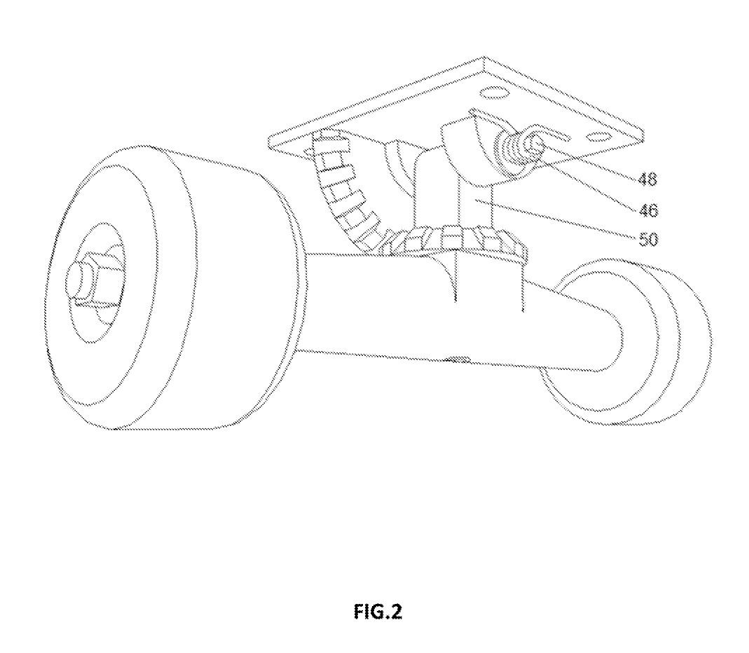

Another embodiment is illustrated in FIG. 2 and constitutes the same description of the first embodiment described above and as seen in FIG. 1A-1C, with the exception of an alternative suspension system. Rather than using coil springs and spring mounts to generate a resistive force to keep the base platform 10 level, a latch spring 46 is fixed to the half circle end of an otherwise full circle grooved bolt 48. The grooves in bolt 48 fit securely into a channeled hole through the top of swing arm 50, forming concurrent motion between bolt 48 and swing arm 50. This embodiment allows the restoring force in latch spring 46 to return the base platform 10 to a level position and the pivoting axle 18 back to its original orientation.

In still another embodiment, a standard shock absorber can be implemented to act as the suspension system. This piston and fluid filled cylinder provides damping similar to the springs described above.

The disclosed weight displacement steering mechanism can be incorporated into a variety of devices which are briefly described below. These various devices contain different numbers and configurations of wheels, skis, runners and the like, that are fastened to the weight displacement steering mechanism by of the arm bolt 36 and pins 38 shown in FIG. 1D.

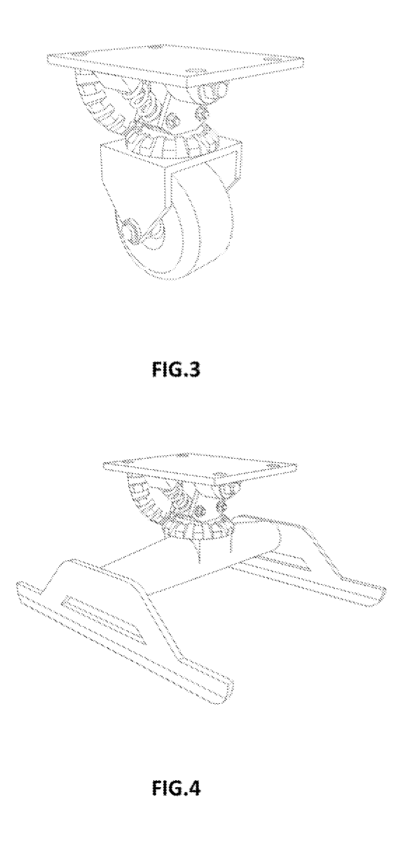

FIG. 3 illustrates the weight displacement steering mechanism configured with a single wheel. This single wheel is rototably connected to a mount fastened beneath the horizontal bevel gear 16 by arm bolt 36.

FIG. 4 illustrates the weight displacement steering mechanism configured with a pair of parallel runners fixed to an axle.

FIG. 5 illustrates the weight displacement steering mechanism configured with a single runner. This single runner is connected to a mount fastened beneath the horizontal gear 16 by arm bolt 36.

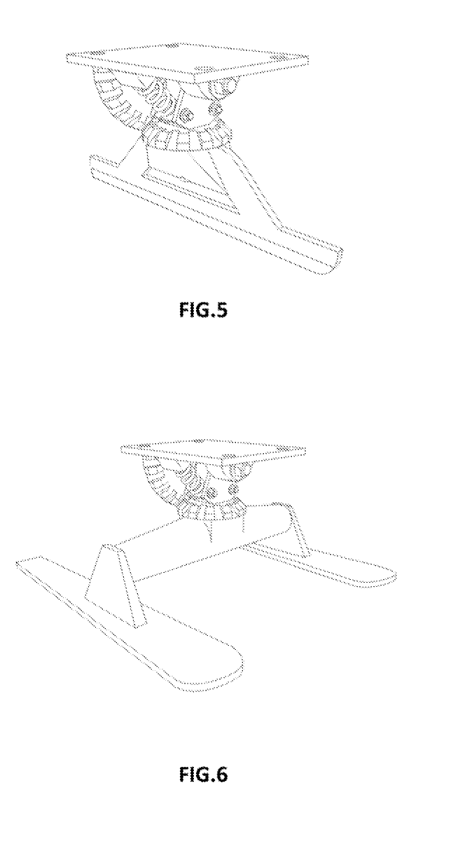

FIG. 6 illustrates the weight displacement steering mechanism configured with a pair of skis fixed to an axle.

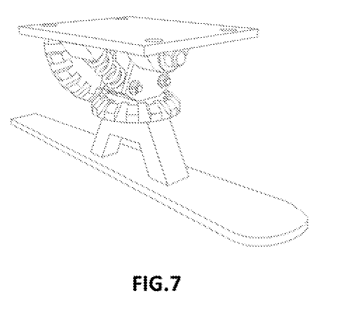

FIG. 7 illustrates the weight displacement steering mechanism configured with a single ski. This single ski is connected to a mount fastened beneath the horizontal gear 16 by arm bolt 36.

These devices all utilize the weight displacement steering mechanism illustrated in FIG. 1D and described above. Additionally, the size ratio of the first bevel gear 16 to the second bevel gear 17 may be varied for these configurations, and springs 20 with different spring constants and different structures, as described above, may be implemented in these devices.

Accordingly, the reader will see that the weight transfer, steering mechanism described in the various embodiments can be an easy to use, effective and affordable mode of vehicle steering for a large segment of people. In addition, for recreational equipment, the embodiments will have a greater appeal to beginners, those living in congested urban environments, and those who are simply not satisfied with current designs' lacking ability to perform small radius turns. Furthermore, the steering mechanism has the additional advantages in that:
It permits a greater turn-to-tilt ratio, allowing riders' to more easily remain balanced and in control of the vehicle.
Its minimal moving parts design allows for affordable production and purchase.
It permits springs of various tensile strength to be used, adjusting to a rider's weight, height, and preferences.
It allows for single or multiple wheel design.
   It can implement ski(s) or skate(s) instead of wheel(s).
   Its compact and short design is inconspicuous and nonintrusive.
   Its identical front and back, truck design allows for easy manufacturing.
   All moving parts are positioned below the platform, which is safer—especially for sleds.

Although the description above describes many specific features, these should not be construed as limiting the scope of the embodiments but as merely providing illustrations of some of the presently preferred embodiments. For example, the steering mechanism could be sized to fit a motorcycle, tri wheel vehicle, ATV, or even larger means of transportation; the axle and wheels could be replaced by a single wheel and mount; the wheel(s) could be replaced by ski(s), skate(s), or other devices. Therefore the scope of the embodiment should be determined by the appended claims, rather than of the examples given above.

1. A steering device comprising:
a base plate;
an arm attached to the bottom of said base plate by a hinge mechanism;
a suspension system attached between said arm and said base plate such that said suspension system acts to return said base plate from a tilted to a horizontal position;
a first bevel gear positioned horizontally below said arm and capable of rotating; and
a second bevel gear attached vertically to the bottom of said base plate and engaged with said first bevel gear such that when weight is displaced to one side of said base plate, said base plate tilts causing said second bevel gear to rotate, causing said first bevel gear to pivot.

2. The device of claim 1 wherein said suspension system comprises;
pivoting mounts mounted on opposite sides in the lower, area of said arm;
non-pivoting mounts mounted on the bottom of said base plate; and
springs, mounted under compression, between said pivoting mounts and said non-pivoting mounts.

3. The device of claim 1 wherein said suspension system comprises a latch spring.

4. The device of claim 1 wherein said suspension system comprises shock absorbers.

5. The device of claim 1 wherein a fixture holding a wheel is attached to the bottom of said first bevel gear.

6. The device of claim 1 wherein a fixture holding a ski is attached to the bottom of said first bevel, gear.

7. The device of claim 1 wherein a fixture holding a runner is attached to the bottom of said first bevel gear.

8. The device of claim 1 wherein an axle is fastened to the bottom of said first bevel gear such that the pivoting of said first bevel gear coincides with the pivoting of said axle.

9. The device of claim 8 wherein wheels are attached to said axle.

10. The device of claim 8 wherein skis are attached to said axle.

11. The device of claim 8 wherein runners are attached to said axle.

12. A steering device comprising:
a base plate;
a first bevel gear attached to said base plate;
a second bevel gear engaged with said first bevel gear and attached to an axle;
wherein tilting of said base plate causes motion of said first bevel gear;
wherein said motion of said first bevel gear causes motion of said second bevel gear; and
wherein said motion of said second bevel gear causes a change in alignment between said axle and said base plate.

13. The device of claim 12 further comprising:
an arm attached to the bottom of said base plate by a hinge mechanism and attached to said axle.

14. The device of claim 13 further comprising:
a suspension system attached between said arm and said base plate such that said suspension system acts to return said base plate to a horizontal position.

15. The device of claim 14 wherein said suspension system comprises a latch spring.

16. The device of claim 14 wherein said suspension system comprises shock absorbers.

17. The device of claim 12 wherein a fixture holding a wheel is attached to the bottom of said first bevel gear.

18. The device of claim 12 wherein a fixture holding a ski is attached to the bottom of said first bevel gear.

19. The device of claim 12 wherein wheels are attached to said axle.

20. The device of claim 12 wherein skis are attached to said axle.
